(19) United States
(12) Patent Application Publication
(10) Pub. No.: US 2013/0311336 A1
(43) Pub. Date: Nov. 21, 2013

(54) PRICE NEGOTIATION FROM USER DEVICE

(71) Applicant: Subbu Srinivasan, Milpitas, CA (US)

(72) Inventor: Subbu Srinivasan, Milpitas, CA (US)

(21) Appl. No.: 13/829,930

(22) Filed: Mar. 14, 2013

Related U.S. Application Data
(60) Provisional application No. 61/648,502, filed on May 17, 2012.

(51) Int. Cl. G06Q 30/06

(52) U.S. Cl. CPC G06Q 30/0601
USPC 705/26.81

(57) ABSTRACT

A consumer is able to negotiate directly with a merchant through the user's computing device by simply selecting a button or link. When the consumer or user locates an item of interest, the user may see a “Negotiate” or similar button or link displayed with the item and price, along with a “Purchase” or similar button. The “Negotiate” button indicates to the user that the seller or merchant is willing to negotiate a price on the item. The user can submit a proposed price, receive a counter-offer, propose a new price, purchase the item, place the item on a wish list, and/or posting a purchase or “like” to a social network or other site.

### CROSS REFERENCE TO RELATED APPLICATION

This application claims priority to U.S. Provisional Patent App. Ser. No. 61/648,502, filed May 17, 2012, which is incorporated by reference in its entirety.

### BACKGROUND

1. Field of the Invention

The present invention generally relates to electronic shopping.

2. Related Art

Consumers typically make purchases electronically through computing devices, such as PCs and more recently smart phones and tablets. Once the consumer finds a desired item at a desired price, the consumer makes the purchase and the item is shipped or picked up. One disadvantage (and advantage) to this process is that the consumer knows the exact price offered for the item and makes the decision to purchase based on this fixed price.

Other ways to purchase electronically include online auction site, such as from eBay. Such sites allow sellers to offer items for sale to the highest bidder or the first to accept a fixed price. The seller may set a minimum bid the seller would accept to ensure at least a minimum price if the item was sold. This allows potential buyers to bid against each other, but also possibly obtain an item at a lower price than available elsewhere if the seller has no or a low minimum and the bidding by others (if any) has not pushed the price too high.

However, for the same reasons that a good deal may be found by the consumer, the item may quickly be priced out of the consumer's desired price by other buyers. This is the result of an open auction system where anyone can bid on an item.

### BRIEF DESCRIPTION OF THE FIGURES

FIGS. 1A and 1B are flowcharts showing a process for negotiating a purchase between a user and a merchant through a user computing device according to one embodiment;

FIG. 2 is block diagram of a networked system suitable for implementing the process described herein according to an embodiment; and

FIG. 3 is a block diagram of a computer system suitable for implementing one or more components in FIG. 2 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a consumer is able to negotiate directly with a merchant through the user's computing device by simply selecting a button or link. When the consumer or user locates an item of interest, the user may see a “Negotiate” or similar button or link displayed with the item and price, along with a “Purchase” or similar button. The “Negotiate” button indicates to the user that the seller or merchant is willing to negotiate a price on the item.

A field or box may also be displayed to allow the user to enter a proposed price. Upon entering the price, the user can select the button to convey the offer to the merchant. The merchant may accept the offer, decline the offer, or propose a new price for the item and convey the response to the user device.

If the offer is accepted, the user may select a “Buy” or “Purchase” button to make the payment to the merchant through the user device. The merchant may receive confirmation of payment and deliver the item or have it ready for pick up by the user.

If the offer is declined, the user may be given the option of submitting another amount or accepting the list price. The user may also be given the option of placing the item on a wish list, such that the user may be notified if/when the item or a similar item by the same or different merchant is offered at a lower price or at a price closer to the user's bid or offer price.

If the user is allowed to propose a new price, the negotiating continues, with the merchant accepting the price, declining, or giving the user another opportunity to submit a higher offer. At some point (such as after a set number of offers or negotiations), the user may not have the option to submit any more offers, with the only options being to select the listed price or not.

The user may also see a “Like” button before, during, or after the negotiating. By selecting the “Like” button, a “Like” or recommendation may be posted to one or more social sites under the user's account, page, or wall.

As a result, a user is able to negotiate directly with a merchant on a particular item quickly and easily through the user's computing device. The negotiate feature may be enabled when the user is in proximity to a merchant such that the user can easily pick up the purchase in person if a negotiation is successful.

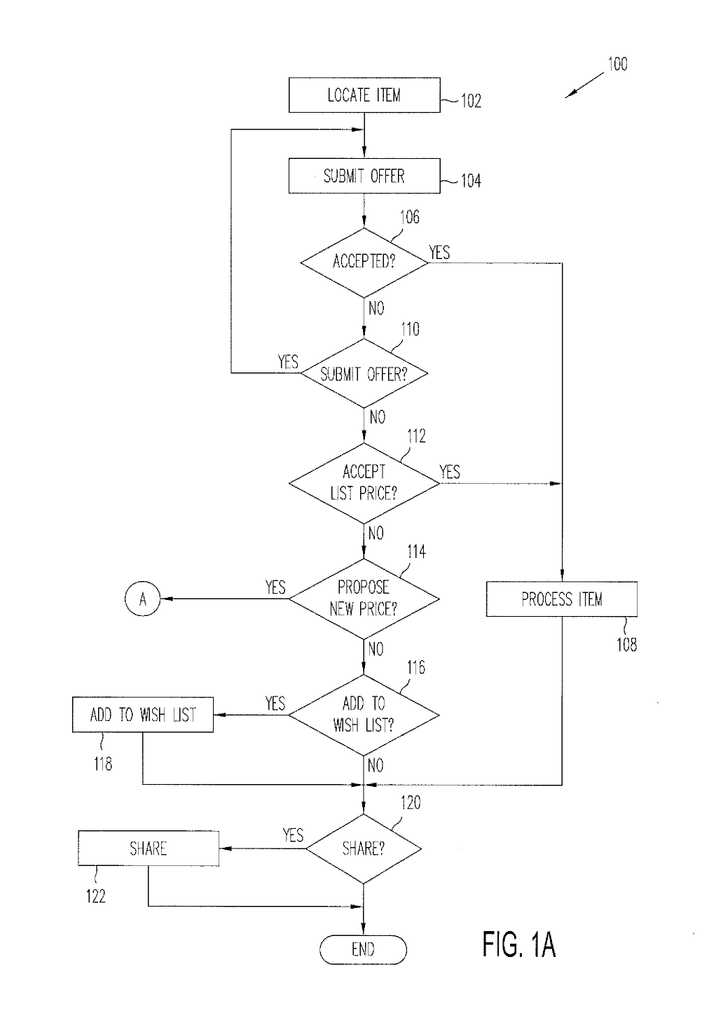

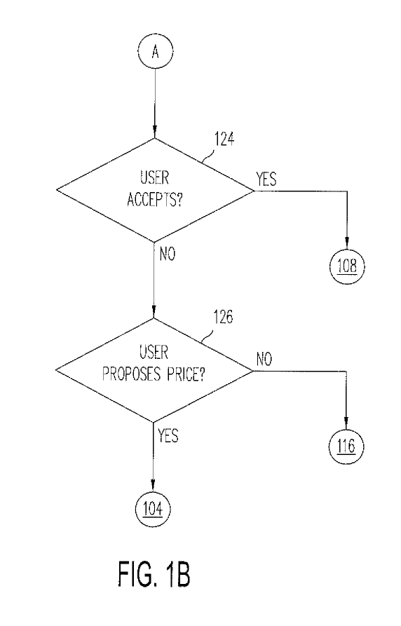

FIGS. 1A and 1B are flowcharts showing a process 100 for negotiating a purchase between a user and a merchant through a user computing device according to one embodiment. At step 102, the user locates an item for possible purchase on a user device, such as a smart phone, computing tablet, or PC. The item may be located through a search on the user device, a listing on a merchant site, a notification from a merchant or service provider on the user device, or other means. The item may be viewed through a service or payment provider site or app or through a merchant site or app.

The display may include a description of the item, a price, a merchant identifier, a “buy” button or link, and/or a “negotiate” button or link. The “negotiate” button or link can be any indication to the user that the merchant is willing to negotiate a price for the item.

If the user desires to use this option, the user may submit an offer, at step 104. This may include entering an amount in a field on the display of the user device and selecting the “negotiate” button to transmit the offer to the merchant. The user may enter the amount through a key pad, voice or other means. Alternatively, the user may choose the merchant offered price and complete the purchase through the user device, as described below.

Once received, the merchant determines whether to accept the offer, at step 106. The determination may be automatic or manual. For the former, the merchant may have set up a minimum acceptable amount for the item, such that when an offer is received, a comparison is made as to whether the received offer is equal to or greater than the specified minimum amount. For the latter, the merchant may view the amount, such as on a merchant computing device, and make a decision whether to accept or not. During this decision period, the user may see an indication on the user device that the offer is being considered.

If the offer is accepted by the merchant, such as the merchant selecting an “accept” button or other means or from an automatic response of acceptance if the offer is at or above a minimum acceptable amount, the purchase transaction may be processed, at step 108. Processing may include a service or payment provider, such as PayPal, Inc., receiving merchant information, user information (such as through the user device), item information, agreed-upon price, and determining whether the payment can be approved. If the user has not already been authenticated by the service provider, authentication may be required by the user entering a password or PIN, along with a user identifier, such as a name, email address, or phone number if needed. Processing may include debiting an account of the user with the payment provider and crediting an account of the merchant.

Assuming the payment is approved, the user and/or the merchant may be notified, such as through the user device and/or the merchant device. The user may receive the purchased item, such as shipped by the merchant to the user address stored with the payment provider or picked up by the user at a merchant location. Shipping information may be conveyed from the payment provider to the merchant through information available with the user's payment provider account.

After the purchase is made, the user may see a “share” button or link on the user device that enables the user to “like” or share the merchant and/or purchase on one or more social sites. The user may select the button, which will cause an appropriate posting on the user's page on a social site.

Returning back to step 106, if the offer is not acceptable to the merchant, the user may be given an option to submit another offer at step 110. For example, the merchant may communicate a message to the user device that the offer was declined, but that the user can submit another offer if desired. If the user wishes to submit another offer, as determined at step 110, the user submits another amount, at step 104. The user may be given a certain number of chances to submit a new offer for the merchant to consider. If any of the new offers are accepted, as determined at step 106, the payment request is processed at step 108.

However, if the user does not wish to submit a new offer or the user is not given the option of submitting a new or any more offers, the user decides whether to accept the listed price at step 112. If the user decides to purchase at the listed price, the user may select a “buy” button associated with the listed price, which communicates the acceptance to the merchant and/or the payment provider. The payment request may then be processed at step 108 as discussed above.

However, if the user does not accept the listed price and the user cannot or does not submit any acceptable offers, the merchant may propose, at step 114, an acceptable price, which may be between the user's last offer and the merchant's listed price. For example, the merchant may transmit the proposed new price, through an automatic system or manually entered by the merchant, to the user device.

Referring to FIG. 1B, the merchant proposed price is reviewed by the user on the user device, who determines whether to accept the offer at step 124. If accepted, the user can select a suitable button or link to convey the acceptance to the merchant and/or payment provider. The payment request is then processed at step 108 as discussed above in FIG. 1A.

If the user does not accept the merchant proposed price, the user may be given the option or decide whether to submit a price acceptable to the user, at step 126. If the user can and desires to submit a new amount, the user can submit the offer at step 104 as discussed with FIG. 1A. This price may be less than the merchant proposed price, but greater than an earlier user submitted offer. The user may convey this new price through the user device to the merchant and/or payment provider for the merchant to consider.

Thus, the user and merchant may continue to negotiate on an acceptable price, with each party submitting new proposed offers. The user is free to accept the most current offer (if still valid) or the list price during the negotiation. However, if the user does not want to or cannot propose a new price, the user and merchant cannot agree on an acceptable price, and no purchase is made at this time.

Returning to FIG. 1A, the user may then decide whether to place the item on a wish list at step 116. The user may be asked to select a button or link to add the current item to a wish list. By selecting the button or link, the merchant and/or payment provider may be notified through the user device, along with information about the item, such as current list price (or latest merchant or user offered price during a negotiation) and description. The item is then added to a user wish list at step 118. The wish list may be stored with the user account with the payment provider and include information about the item and price information, such as the original list price of the item, a revised offer price from the merchant, a last offer price by the user, etc. A notification may then be sent to the user on the user device based on various triggers. Examples of triggers include the merchant or another merchant offering the item at a price lower than the original list price or a different merchant proposed price or the merchant or another merchant offering the item at or lower than a price previously submitted by the user.

At step 120, the user may decide whether to share the item. A button or link may be displayed on the user device, such as a “like” button or other indicator. The indicator may be displayed at any time, from the time the item is first presented to the user on the device to after payment. By selecting the “like” or similar indicator, the user communicates a desire to share or “like” the merchant and/or the purchase to one or more user social networks, such as a user's page on a social network or a tweet.

Note that one or more of the steps above may be combined, omitted, or performed in a different sequence is desired and appropriate.

Thus, a user is able to quickly and easily negotiate a purchase at a lower price than listed by the merchant, as well as be notified of price drops if no purchase is able to be completed during the negotiation on the user device.

In one embodiment, items and/or merchants may be pushed or displayed on the user device when the user is within a certain proximity to a merchant. The distance may vary depending on location, speed of travel by the user, or other factors. For example, a longer distance may be used if the system determines that the user is traveling in a car or other motorized vehicle and/or in a sparsely populated shopping area. A shorter distance may be used if the user is walking and/or in a densely populated shopping area. As such, a user may be more likely to complete a purchase and be able to pick up the purchase from a local merchant.

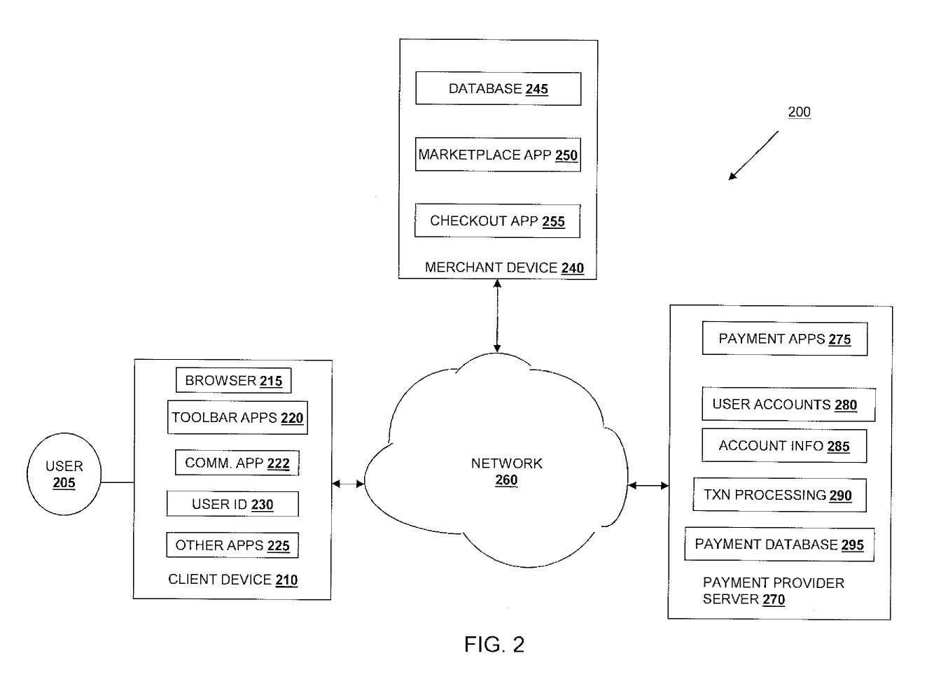

FIG. 2 is a block diagram of a networked system 200 configured to handle a transaction, such as described above, in accordance with an embodiment of the invention. System 200 includes a user device 210, a merchant device 240, and a payment provider server 270 in communication over a network 260. Payment provider server 270 may be maintained by a payment provider, such as PayPal, Inc. of San Jose, Calif. A user 205, such as a sender or consumer, utilizes user device 210 to perform a transaction using payment provider server 270. Note that transaction, as used herein, refers to any suitable action performed using the user device, including payments, transfer of information, display of information, etc. Although only one merchant device is shown, a plurality of merchant devices may be utilized if the user is negotiating with multiple merchants.

User device 210, merchant device 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks. User device and merchant device 240 may communicate directly, such as through NFC means like Bluetooth, if the negotiate feature is enabled based on location.

User device 210 may be implemented using any appropriate hardware and software configured for wired and/or wireless communication over network 260. For example, in one embodiment, the user device may be implemented as a personal computer (PC), a smart phone, personal digital assistant (PDA), computing tablet, and/or other types of computing devices capable of transmitting and/or receiving data.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet, such as items listed or offered by a merchant. User device 210 may also include one or more toolbar applications 220 which may be used, for example, to provide client-side processing for performing desired tasks in response to operations selected by user 205. In one embodiment, toolbar application 220 may display a user interface in connection with browser application 215.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include email, texting, voice and IM applications that allow user 205 to send and receive emails, calls, and texts through network 260, as well as applications that enable the user to communicate, transfer information, make payments, and otherwise negotiate prices with a merchant through the payment provider as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider as further described herein. A communications application 222, with associated interfaces, enables user device 210 to communicate within system 200.

Merchant device 240, such as a server or computing device with a display, may be maintained, for example, by a merchant or seller offering various products and/or services in exchange for payment to be received over network 260. Merchant device 240 may be used for offline brick and mortar or for online purchases and transactions. Generally, merchant device 240 may be maintained by anyone or any entity that receives money, which includes retailers and restaurants. Merchant device 240 includes a database 245 identifying available products and/or services (e.g., collectively referred to as items) which may be made available for viewing and purchase by user 205. Accordingly, merchant device 240 also includes a marketplace application 250 which may be configured to serve information over network 260 to browser 215 of user device 210. In one embodiment, user 205 may interact with marketplace application 250 through browser applications over network 260 in order to view various products, food items, or services identified in database 245, including options to negotiate, like, and/or share as described herein..

Merchant device 240 also includes a checkout application 255 which may be configured to facilitate the purchase by user 205 of goods or services identified by marketplace application 250. Checkout application 255 may be configured to accept payment information from or on behalf of user 205 through payment service provider server 270 over network 260. For example, checkout application 255 may receive and process a payment confirmation from payment service provider server 270, as well as transmit transaction information to the payment provider and receive information from the payment provider (e.g., a transaction ID) based on an agreed-upon price between the merchant and user for the item(s).

Payment provider server 270 may be maintained, for example, by an online payment service provider which may provide payment between user 205 and the operator of merchant server 240. In this regard, payment provider server 270 includes one or more payment applications 275 which may be configured to interact with user device 210 and/or merchant device 240 over network 260 to facilitate the purchase of goods or services, communicate/display information, and send payments by user 205 of user device 210 and as discussed above.

Payment provider server 270 also maintains a plurality of user accounts 280, each of which may include account information 285 associated with individual users, including wish lists populated with user selected items. For example, account information 285 may include private financial information of users of devices such as account numbers, passwords, device identifiers, user names, phone numbers, credit card information, bank information, or other financial information which may be used to facilitate online transactions by user 205. Account information may also include user purchase history, which may include search history, as well as wish list and pricing information discussed herein. Advantageously, payment application 275 may be configured to interact with merchant server 240 on behalf of user 205 during a transaction with checkout application 255 to track and manage purchases made by users and which funding sources are used, as well as notify a user of price reductions from a user wish list.

A transaction processing application 290, which may be part of payment application 275 or separate, may be configured to receive information from a user device and/or merchant device 240 for processing and storage in a payment database 295. Transaction processing application 290 may include one or more applications to process information from user 205 for processing an order and payment as described herein. As such, transaction processing application 290 may store details of an order associated with individual users. Payment application 275 may be further configured to determine the existence of and to manage accounts for user 205, as well as create new accounts if necessary, such as the set up, management, and use of wish lists and sharing functions for users as discussed herein.

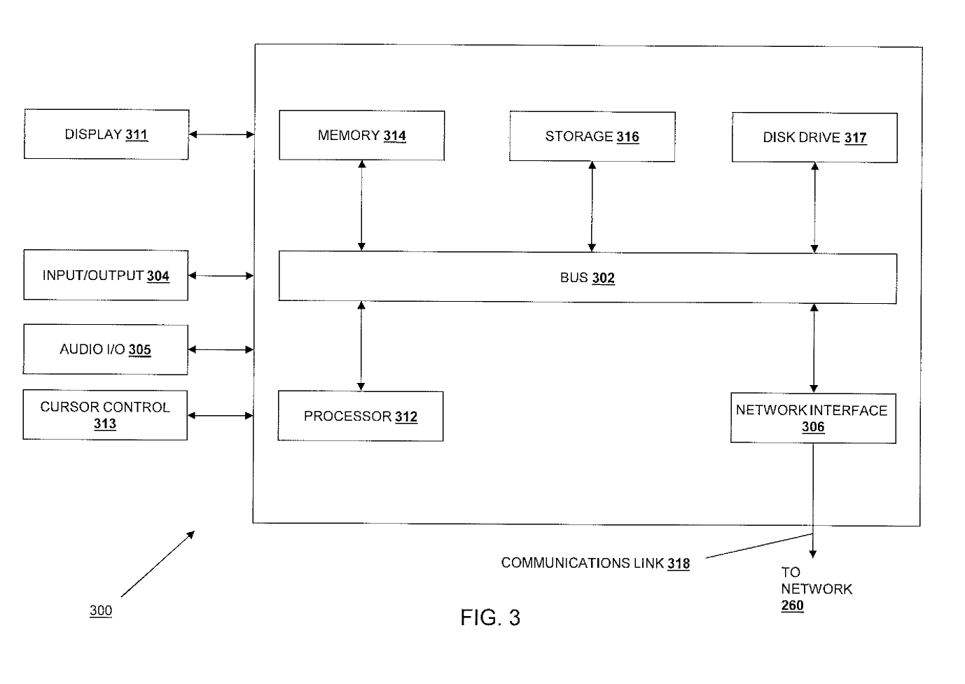

FIG. 3 is a block diagram of a computer system 300 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 360. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a memory storing account information for a plurality of users, wherein the account information comprises information about a price agreed upon by a merchant and user for an item or a price for an item of interest to the user but not yet purchased;
one or more processors operable to:
receive, from a user, a first price offered to a merchant for an item displayed on a user device, wherein the first price is lower than a listed price for the item on the user device;
receive, from the merchant, an indication whether the first price is accepted by the merchant for the item; and
process a payment from the user to the merchant at the first price for the item if the first price is accepted by the merchant.

2. The system of claim 1, wherein the user device comprises an indication that the merchant is willing to receive an offer from the user for a specific item to purchase.

3. The system of claim 1, wherein when the first price is not accepted by the merchant, the merchant provides the user an option to submit a second price.

4. The system of claim 3, wherein the second price is higher than the first price and lower than the listed price.

5. The system of claim 1, wherein the payment is processed when the user accepts a second price offered by the merchant.

6. The system of claim 5, wherein the second price is equal to the listed price.

7. The system of claim 5, wherein the second price is lower than the listed price and higher than the first price.

8. The system of claim 1, wherein the user is given an option displayed on the user device of adding the item to a wish list.

9. The system of claim 8, wherein the user is notified on the user device when the item is offered at a price lower than the listed price.

10. The system of claim 1, wherein the user is given an option displayed on the user device of posting the item and/or the merchant on a social site or network.

11. The system of claim 1, wherein the item is displayed when the user is within a certain distance from the merchant.

12. A non-transitory machine-readable medium comprising a plurality of machine-readable instructions which when executed by one or more processors of a server are adapted to cause the server to perform a method comprising:
receiving, from a user device, a first price offered to a merchant for an item displayed on a user device, wherein the first price is lower than a listed price for the item on the user device;
receiving, from a merchant device, an indication whether the first price is accepted by the merchant for the item; and
processing a payment from the user to the merchant at the first price for the item if the first price is accepted by the merchant.

13. The non-transitory machine-readable medium of claim 12, wherein the user device comprises an indication that the merchant is willing to receive an offer from the user for a specific item to purchase.

14. The non-transitory machine-readable medium of claim 12, wherein when the first price is not accepted by the merchant, the merchant provides the user an option to submit a second price.

15. The non-transitory machine-readable medium of claim 12, wherein the payment is processed when the user and the merchant agree upon a price for the item that is higher than the first price and lower than the listed price.

16. The non-transitory machine-readable medium of claim 12, wherein the item is displayed when the user is within a certain distance from the merchant.

17. The non-transitory machine-readable medium of claim 12, wherein the method further comprises receiving an item to add to a wish list from the user device and notifying the user on the user device when the item is offered at a price lower than the listed price.

18. A method for performing a transaction using a user device, comprising:
receiving, by a hardware processor of a service provider from a user device, a first price offered to a merchant for an item displayed on a user device, wherein the first price is lower than a listed price for the item on the user device;
receiving, from a merchant device, an indication whether the first price is accepted by the merchant for the item; and
processing a payment from the user to the merchant at the first price for the item if the first price is accepted by the merchant.

19. The method of claim 18, wherein the user device comprises an indication that the merchant is willing to receive an offer from the user for a specific item to purchase.

20. The method of claim 18, wherein when the first price is not accepted by the merchant, the merchant provides the user an option to submit a second price.

21. The method of claim 18, wherein the payment is processed when the user and the merchant agree upon a price for the item that is higher than the first price and lower than the listed price.

22. The method of claim 18, wherein the item is displayed when the user is within a certain distance from the merchant.

23. The method of claim 18, further comprising receiving an item to add to a wish list from the user device and notifying the user on the user device when the item is offered at a price lower than the listed price.
